(19) United States
(12) Patent Application Publication
(10) Pub. No.: US 2008/0030687 A1
(43) Pub. Date: Feb. 7, 2008

(54) Image display device

(75) Inventors: Takeshi Nakane, Shibuya-ku (JP); Kazuya Yamanaka, Shibuya-ku (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: OLYMPUS CORPORATION, Tokyo (JP)

(21) Appl. No.: 11/717,981

(22) Filed: Mar. 14, 2007

(30) Foreign Application Priority Data
Aug. 4, 2006 (JP) 2006-213805

(51) Int. Cl. G03B 21/14

(52) U.S. Cl. 353/20

(57) ABSTRACT

An image display device for displaying a high quality and high resolution image without causing color irregularities, adapted to be assembled simply and at low cost. The device includes a plurality of spatial light modulation elements (6R, 6G; 6B) illuminated by lights of different colors for performing an image modulation; a color synthesizer (7) for synthesizing image lights modulated by each of the spatial light modulation elements; an incident polarized light controller (10) for converting at least one of the plurality of image lights of different colors projected to the color synthesizer, into a different polarization than those of the other image lights; and a pixel shift device (15) that includes at least one set of a polarization conversion element (21) and a double refraction plate (22). The pixel shift device (15) selectively shifts the optical paths of the image lights synthesized by the color synthesizer. A color-selective polarization converter (25) is arranged between the polarization conversion element (21) and the double refraction plate (22) forming a first set in the pixel shift device (15). The color-selective polarization converter (25) forms an integral a unit with the pixel shift device and aligning polarizations of the plurality of image lights from the polarization conversion element (21) to each other before the image lights are projected to the double refraction plate (22).

### BACKGROUND OF THE INVENTION

1. Field of the Invention

The present invention relates to an image display device and, more particularly, to an image display device wherein image lights are subjected to an image modulation of different colors by a plurality of spatial light modulation elements, the modulated image lights are synthesized by a color synthesizer, and the synthesized image light is displayed while selectively shifting an optical path thereof by a pixel shift device.

2. Description of Related Art

As a conventional image display device, there is known a 3LCD-type image display device wherein a light from a white light source is separated into a red (R) light, a green (G) light and a blue (B) light, and the separated lights are projected to respective liquid crystal display elements as spatial light modulation elements and thereby subjected to image modulation. The modulated R, G and B lights are synthesized by a color synthesizer in the form of a dichroic prism, for example, and then displayed on a screen through a projection lens.

In such a 3LCD-type image display device, the synthesized image light may be subjected to a wavelength shift due to incidence angle characteristics of a dichroic film of the dichroic prism, thereby causing color irregularities. This sort of color irregularities may occur particularly when an integrator optical system is arranged in an illumination optical system, in order to equalize the illumination distribution of an illumination light emitted from the white light source. This is because the image lights modulated by the respective liquid crystal display elements are projected to the dichroic film at different incidence angles.

For eliminating such a problem, there is known a method that takes into account the polarization characteristics of the dichroic film, such that the G image light is projected to, and transmitted through the dichroic film in P-polarization, whereas the R and B image lights are projected to, and reflected on the dichroic film in S-polarization, before the R, G and B image lights are synthesized.

Also, various image display devices have been proposed, wherein the optical paths of the image lights subjected to image modulation by spatial light modulation elements are selectively shifted by pixel shift device, so as to achieve a high resolution. Reference may be had, for example, to Patent Document 1 identified below.

The pixel shift device includes, as shown in FIG. 9 by way of example, a polarization conversion element 110 and a double refraction plate 111, such as a liquid crystal panel and a quartz plate, for example. The polarization conversion element 110 selectively rotates the direction of the linear polarization of the modulated image light by 90 degrees while being synchronized with the image modulation by the spatial light modulation elements (not shown), so that the double refraction plate 111 shifts the optical path of the image light according to the direction of the linear polarization, for example, by half a pixel pitch with respect to a horizontal pixel arrangement of the spatial light modulation elements. There are also known a pixel shift device in which a plurality of sets of a polarization conversion element 110 and a double refraction plate 111 are provided so that the position of a displaying pixel can be selectively shifted in different directions, for example, in the horizontal direction, in the vertical direction, or in the oblique direction.

There is also known an image display device in the form of combination of the above mentioned 3LCD image display device and the pixel shift device shown in FIG. 9, in which the optical path of the image light synthesized by the dichroic prism is selectively shifted by the pixel shift device so as to achieve a high resolution.

FIG. 10 shows the configuration of the relevant parts of such an image display device, including a liquid crystal display element 120R for performing an image modulation for the R light, a liquid crystal display element 120G for performing an image modulation for the G light, a liquid crystal display element 120B for performing an image modulation for the B light, a dichroic prism 121 for synthesizing the image lights modulated by the liquid crystal display elements 120R, 120G and 120B, a pixel shift device 122 for selectively shifting the optical paths of the synthesized image lights, and a projection lens 123 for projecting the image lights from the pixel shift device 122 onto a screen (not shown). FIG. 10 further shows an example of the pixel shift device 122, which includes a set of a polarization conversion element 110 and a double refraction plate 111, for performing a double-point pixel shift.

In the image display device shown in FIG. 10, however, in an attempt to prevent color irregularities caused by incidence angle characteristics of the dichroic film of the dichroic prism 121, if the G image light from the liquid crystal display element 120G is projected to, and transmitted through the dichroic film in P-polarization, while the R image light and the B image light from the liquid crystal display element 120R and the liquid crystal display element 120B, respectively, are projected to, and reflected by the dichroic film in S-polarization, and those R, G and B image lights are synthesized so that the optical path of the synthesized image lights is selectively shifted by the pixel shift device, the display position of the G image light will be misaligned from the display positions of the R and B lights, because the directions of the linear polarizations of the R, G and B image lights projected to the pixel shift device 122 are not aligned with each other.

More specifically, in the image display device shown in FIG. 10, the G image light is projected to the polarization conversion element 110 of the pixel shift device 122 in P-polarization, whereas the R and B image lights are projected to the polarization conversion element 110 in S-polarization. Accordingly, if the R, G and B image lights are projected to the double refraction plate 111 without changing the directions of the linear polarizations of the incident lights by the polarization conversion element 110, the optical paths of the R and B image lights are not subjected to pixel shift, and only the optical path of the G image light is subjected to a pixel shift, as shown in FIG. 11(a). Conversely, if the directions of the linear polarizations of the incident lights are rotated by 90 degrees by the polarization conversion element 110, the G image light is projected to the double refraction plate 111 in S-polarization, whereas the R and B image lights are projected to the polarization conversion element 110 in P-polarization. Accordingly, the optical paths of the R and B image lights are subjected to a pixel shift, and only the optical path of the G image light is not subjected to pixel shift, as shown in FIG. 11(b). Therefore, the display position of the G image is misaligned from the display positions of the R and B images, which is an obstacle to achievement of high resolution and which may degrade the image quality.

In order to solve these problems, there has been proposed an image display device wherein a color-selective polarization plane rotation means including a laminated phase plate is arranged between the dichroic prism and the pixel shift device. With such an image display device, the polarization plane of the G light in P-polarization, for example, is rotated and converted into S-polarization, while the polarization planes of the R and B lights are not rotated so as to remain in S-polarization, so that the polarization directions of the image lights of different colors projected to the pixel shift device are aligned with S-polarization. Reference may be had, for example, to Patent Document 2 identified below.

Patent Document 1: JP 2813041B2

Patent Document 2: JP 2003-207747A

In the case of pixel shift device such as that disclosed in JP 2813041B2 mentioned above, it is common to make the pixel shift device into a unit in order to assemble it while managing the specific characteristics inherent to the pixel shift device.

Therefore, in the case of an arrangement wherein a color-selective polarization plane rotation means in the form of a laminated phase plate is simply arranged between the dichroic prism and the pixel shift device, as in the image display device disclosed in JP 2003-207747A, the pixel shift device and the laminated phase plate would be installed separately for assembling the image display device.

Furthermore, since the laminated phase plate is exposed to outside, it is necessary to carry out an advance step of applying an antireflection coating to a purchased laminated phase plate or cleaning the surface of the laminated phase plate for removing dust thereon, resulting in burdensome assembling operation and increased cost.

In addition, the pixel shift may cause a color mixture if, in terms of the polarization conversion characteristics of the laminated phase plate, there are overlaps of a P-polarization component and an S-polarization component in the transitional regions of the polarization conversion at upper or lower edge of the P-S conversion or, in other words, in the transitional region from the longer wavelength band of the B light to the shorter wavelength band of the G light, and the transitional region from the longer wavelength band of the G light to the shorter wavelength band of the R light, as shown in FIG. 12.

More specifically, if there are overlaps of the P-polarization component and the S-polarization component at the boundary regions between the R and G lights and between the G and B lights, a colored light containing a P-polarization component is mixed with the R light that is supposed to be S-polarized in the shorter wavelength band of the R light (RP1) in a transitional region between the P-polarization and the S-polarization, and a colored light containing a P-polarization component is mixed with the G light that is supposed to be S-polarized in the longer wavelength band of the G light (GS1). Similarly, a colored light containing the P-polarization component is mixed with the G light that is supposed to be S-polarized in the shorter wavelength band of the G light (GP1), and a colored light containing the P-polarization component is mixed with the B light that is supposed to be S-polarized in the longer wavelength band of the B light (BS2). Thus, the pixel shift may cause color mixtures if there are mixtures of the P-polarization and S-polarization, to degrade the image quality.

Such a problem may also occur also when the color synthesizer is comprised of a polarizing beam splitter.

### DISCLOSURE OF THE INVENTION

It is a therefore primary object of the present invention to provide an image display device capable of displaying a high quality and high resolution image without causing color irregularities, and adapted to be assembled easily and at low cost.

To this end, a first aspect of the present invention resides in an image display device comprising: a plurality of spatial light modulation elements illuminated by lights of different colors for performing an image modulation; a color synthesizer for synthesizing image lights modulated by said spatial light modulation elements, respectively; an incident polarized light controller for converting at least one of said plurality of image lights of different colors projected to said color synthesizer, into a different polarization than those of the other image lights; a pixel shift device comprised of at least one set of a polarization conversion element and a double refraction plate, said pixel shift device being for selectively shifting the optical paths of the image lights synthesized by said color synthesizer; wherein a color-selective polarization converter is arranged between said polarization conversion element and said double refraction plate forming a first set in said pixel shift device, said color-selective polarization converter forming an integral unit together with said pixel shift device and aligning polarizations of said plurality of image lights from said polarization conversion element with each other, before the image lights are projected to said double refraction plate.

A second aspect of the present invention resides in the image display device according to the first aspect, wherein the color synthesizer comprises a dichroic prism.

A third aspect of the present invention relates to the image display device according to the first aspect, wherein said color synthesizer comprises a polarizing beam splitter.

A fourth aspect of the present invention resides in the image display device according to any one of the first to third aspects, wherein said plurality of spatial light modulation elements comprise three spatial light modulation elements for performing an image modulation for a red light, a green light and a blue light, and said green light is projected to said color synthesizer in P-polarization, while said red light and said blue light are projected to said color synthesizer in S-polarization.

A fifth aspect of the present invention resides in the image display device according to any one of the first to third aspects, wherein said plurality of spatial light modulation elements comprise a spatial light modulation element for performing an image modulation for a green light and a spatial light modulation element for selectively performing an image modulation for a red light and a blue light, and said green light is projected to said color synthesizer in P-polarization, while said red light and said blue light are projected to said color synthesizer in S-polarization.

A sixth aspect of the present invention resides in the image display device according any one of the first to fifth aspects, wherein each of said plurality of spatial light modulation elements is a transmissive spatial light modulation element.

A seventh aspect of the present invention resides in the image display device according to any one of the first to fifth aspects, wherein each of said plurality of spatial light modulation elements is a reflective spatial light modulation element.

An eighth aspect of the present invention resides in the image display device according to any one of the first to seventh aspects, wherein said color-selective polarization converter has such polarization conversion characteristics that it performs a polarization conversion for a light in a wavelength band not being overlapped with those of said lights of different colors which are not subjected to a polarization conversion by said color-selective polarization converter.

According to the present invention, since the color-selective polarization converter is arranged between the first set of the polarization conversion element and the double refraction plate of the pixel shift device so as to form an integral unit with the pixel shift device, and the color-selective polarization converter aligns the polarizations of the plurality of image lights from the polarization conversion element projected to the double refraction plate, a high quality and high resolution image can be displayed without causing color irregularities, besides that the color-selective polarization converter can be assembled in a simple manner and at low cost.

### BRIEF DESCRIPTION OF THE DRAWINGS

FIG. 1 is a schematic diagram of an image display device according to a first embodiment of the present invention;

FIGS. 2(a) and 2(b) are diagrams explaining the pixel shift operation in the first embodiment;

FIG. 3 is a schematic diagram of an image display device according to a second embodiment of the present invention;

FIGS. 4(a) and 4(b) are diagrams explaining the pixel shift operation in the second embodiment;

FIG. 5 is a schematic diagram of an image display device according to a third embodiment of the present invention;

FIGS. 6(a) and 6(b) are diagrams explaining an image display device according to a fourth embodiment of the present invention;

FIG. 7 is a diagram showing a modification of the pixel shift device;

FIG. 8 is a diagram showing an example of the polarization conversion characteristics of the color-selective polarization converter;

FIG. 9 is a diagram showing a basic configuration of a pixel shift device;

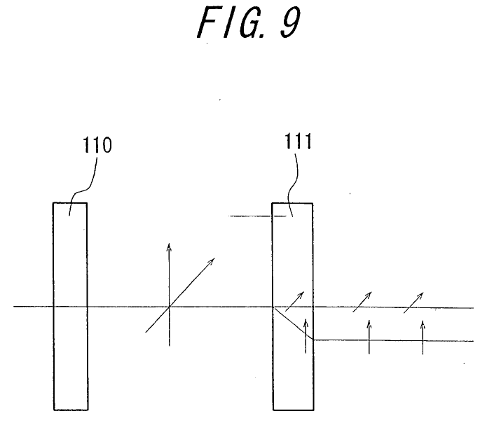

FIG. 10 is a diagram showing a configuration of the relevant parts in a conventional image display device;

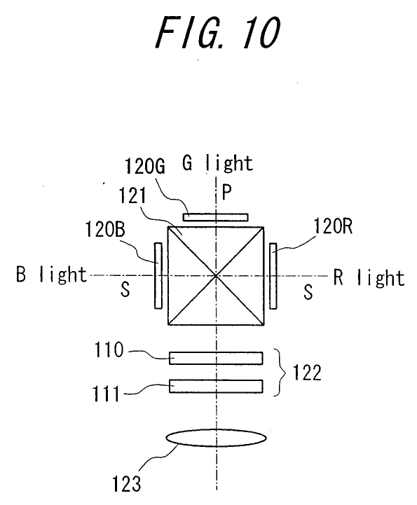

FIGS. 11(a) and 11(b) are diagrams explaining the pixel shift operation in the image display device of FIG. 10; and

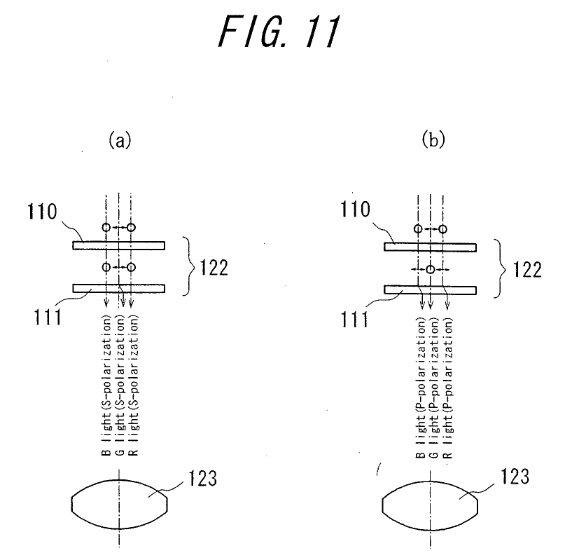

FIG. 12 is a diagram showing an example of the polarization conversion characteristics of a laminated phase plate.

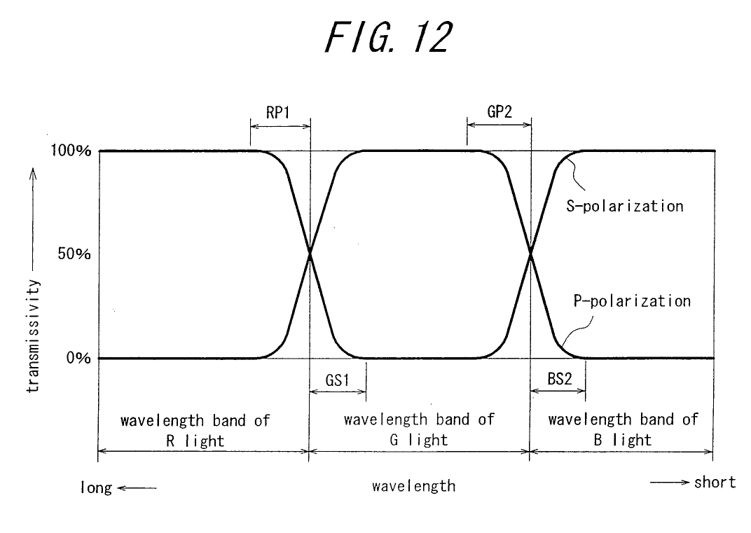

### DESCRIPTION OF THE PREFERRED EMBODIMENTS

The present invention will be explained below with reference to some preferred embodiments shown in the accompanying drawings.

### First Embodiment

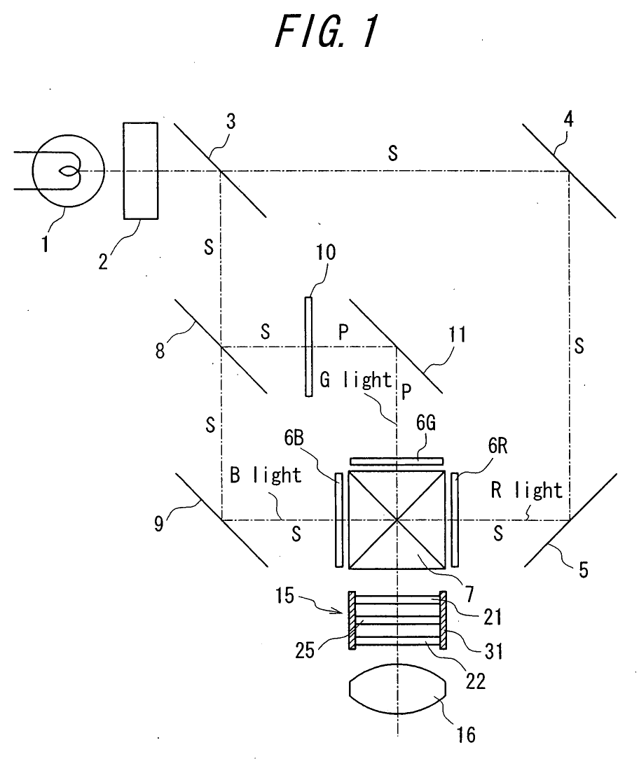

FIG. 1 is a schematic diagram of an image display device according to a first embodiment of the present invention. In this embodiment, three transmissive spatial light modulation elements are used, which are in the form of transmissive liquid crystal display elements, for example, and a dichroic prism is used as a color synthesizer. With reference to FIG. 1, an illumination light from a white light source 1, such as a mercury discharge lamp, is transmitted through an integrator optical system 2 and projected to a dichroic mirror 3 such that the R light is transmitted whereas the lights of other wavelengths are reflected to separate the R light.

The R light separated by the dichroic mirror 3 is projected, via reflecting mirrors 4 and 5, to a spatial light modulation element 6R for the R light as an illumination light, so that the R light is subjected to an image modulation and projected to a dichroic prism 7 as a color synthesizer.

The lights reflected on the dichroic mirror 3, on the other hand, are projected to a dichroic mirror 8 so that the B light is transmitted whereas the G light is reflected, thereby separating the B and G lights from each other. The B light from the dichroic mirror 8 is projected, via a reflecting mirror 9, to a spatial light modulation element 6B for the B light as an illumination light, so that the B light is subjected to an image modulation and then projected to the dichroic prism 7.

The G light separated by the dichroic mirror 8 is projected, via a reflecting mirror 11, to a spatial light modulation element 6G for the G light as an illumination light after the polarization plane thereof has been rotated by 90 degrees by means of a half-wavelength plate 10 as an incident polarized light controller, so that the G light is subjected to an image modulation and projected to the dichroic prism 7.

The integrator optical system 2 may be of a type known, per se, comprised of an optical system including an integrator rod or a fly-eye lens for realizing a substantially uniform illumination intensity distribution of the illumination light for the spatial light modulation elements 6R, 6G and 6B, and a P-S conversion element for converting the emitted light into a predetermined kind of linear polarization.

The dichroic prism 7 reflects the R light modulated by the spatial light modulation element 6R, and the B light modulated by the spatial light modulation element 6B, while transmitting the G light modulated by the spatial light modulation element 6C; in order that the images of the R, G and B lights are synthesized and then emitted.

According to the present embodiment, the light emitted from the integrator optical system 2 is made into S-polarization. The spatial light modulation elements 6R and 6B are respectively illuminated with the R and B lights in S-polarization, and each modulated image light is then projected to the dichroic prism 7 in S-polarization. The spatial light modulation element 6G, on the other hand, is illuminated with the G light in P-polarization since the polarization plane of the G light has been rotated by 90 degrees by means of a half-wavelength plate 10. The modulated G light is then projected to the dichroic prism 7 in P-polarization. Accordingly, a wavelength shift may be made of the synthesized image lights due to incidence angle characteristics of a dichroic film 7a of the dichroic prism 7, so that color irregularities in a displaying image is prevented

The optical paths of the synthesized image lights from the dichroic prism 7 is shifted by a pixel shift device 15, being synchronous with image modulation performed by the spatial light modulation elements 6R, 6G and 6B. The image lights from the pixel shift device 15 is projected and displayed by means of a projector lens 16 onto a screen which is not illustrated.

In the present embodiment, the pixel shift device 15 is of a double-point pixel shift configuration comprising a set of a polarization conversion element 21 and a double refraction plate 22. A laminated phase plate 25 as a color-selective polarization converter is provided between the polarization conversion element 21 and the double refraction plate 22. The polarization plane of the G light is rotated by 90 degrees by means of this laminated phase plate 25, and the polarizations of the R, G and B image lights from the polarization conversion element 21 are aligned with each other and then projected to the double refraction plate 22.

The pixel shift device 15 is made into a unit by holding the polarization conversion element 21 and the double refraction plate 22 integrally with a holder member 31. The laminated phase plate 25 is held with the holder member 31 together with the polarization conversion element 21 and the double refraction plate 22 to be made into a part of the unitized pixel shift device 15. As the laminated phase plate, there may be used a “Color Select” (trade name; manufactured by Color Link Inc., USA).

When the polarization conversion element 21 included in the pixel shift device 15 comprises, e.g., a liquid crystal panel as in the present embodiment, the polarization conversion element 21 transmits the incident light without any conversion of polarization in an ON state where a required voltage is applied to the polarization conversion element 21. On the other hand, in an OFF state where the voltage to the polarization conversion element 21 is shut off, the polarization conversion element 21 transmits the incident light while rotating the polarization plane of the incident light by 90 degrees.

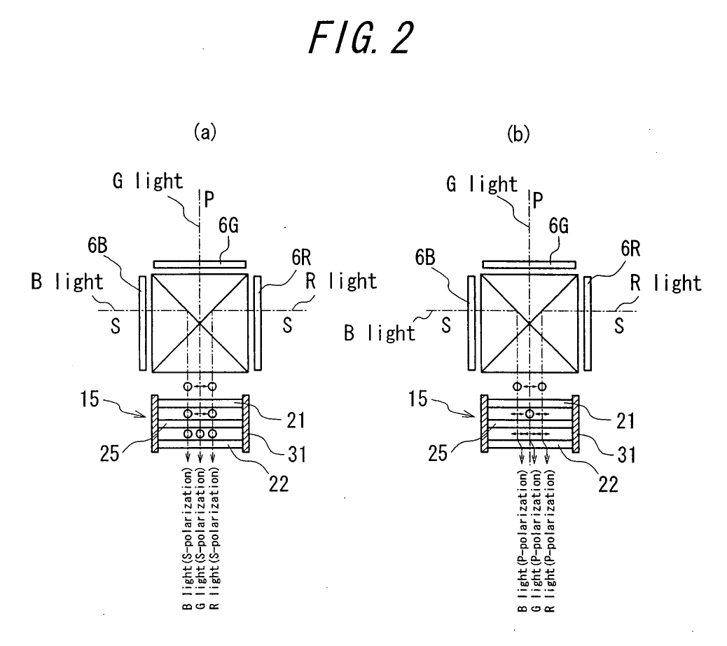

Accordingly, in the ON state of the polarization conversion element 21, the image lights synthesized by the dichroic prism 7 is projected to the laminated phase plate 25 without being subjected to rotation of the polarization plane at the polarization conversion element 21, as shown in a schematic diagram in FIG. 2(a). More specifically, since the G light is projected to the laminated phase plate 25 in P-polarization while the R and B lights are projected to the laminated phase plate 25 in S-polarization, only the polarization plane of the G light is rotated by 90 degrees by means of the laminated phase plate 25 and converted from P-polarization into S-polarization. Accordingly, the R, G and B image lights synthesized by the dichroic prism 7 is projected to the double refraction plate 22 in uniform S-polarization. Thus, each image light is transmitted through the double refraction plate 22 without being subjected, e.g., to an optical path shift.

On the other hand, in the OFF state of the polarization conversion element 21, the image lights synthesized by the dichroic prism 46 are projected to the laminated phase plate 25 while being subjected to rotation of the polarization plane by means of the polarization conversion element 21, as schematically shown in the diagram of FIG. 2(b). More specifically, since the G light is projected to the laminated phase plate 25 in S-polarization while the R and B lights are projected to the laminated phase plate 25 in P-polarization, only the polarization plane of the G light is rotated by 90 degrees by means of the laminated phase plate 25 and thereby converted from S-polarization into P-polarization. Accordingly, the R, G and B image lights synthesized by the dichroic prism 7 are projected to the double refraction plate 22 in uniform P-polarization. Thus, each image light is transmitted through the double refraction plate 22 while being subjected to an optical path shift.

As described above, according to the present embodiment, the modulated images of the R and B lights are projected to the dichroic prism 7 in S-polarization while the modulated image of the G light is projected to the dichroic prism 7 in P-polarization, before the image lights are synthesized. The polarizations of the synthesized image lights are aligned with each other by means of the laminated phase film 25 and subjected to pixel shift. Therefore, it is possible to prevent color irregularities that may be otherwise caused by the incidence angle characteristics of the dichroic prism 7, and to display an image of high quality and high resolution. Further, the pixel shift device 15 is made into a unit by integrally holding the polarization conversion element 21 and the double refraction plate with the holder member 31, and the laminated phase plate 25 for aligning the polarizations of the synthesized image lights is provided between the polarization conversion element 21 and the double refraction plate 22 and held by the holder member 31 to be made into a part of the unitized pixel shift device 15. Therefore, the polarization conversion element 21, the laminated phase plate 25 and the double refraction plate 22 can be joined with an adhesive having a similar refractive index, which will make it possible to assemble it in a simple manner and at low cost without any need of applying an antireflective coating to the laminated phase plate 25 or cleaning the surface thereof.

### Second Embodiment

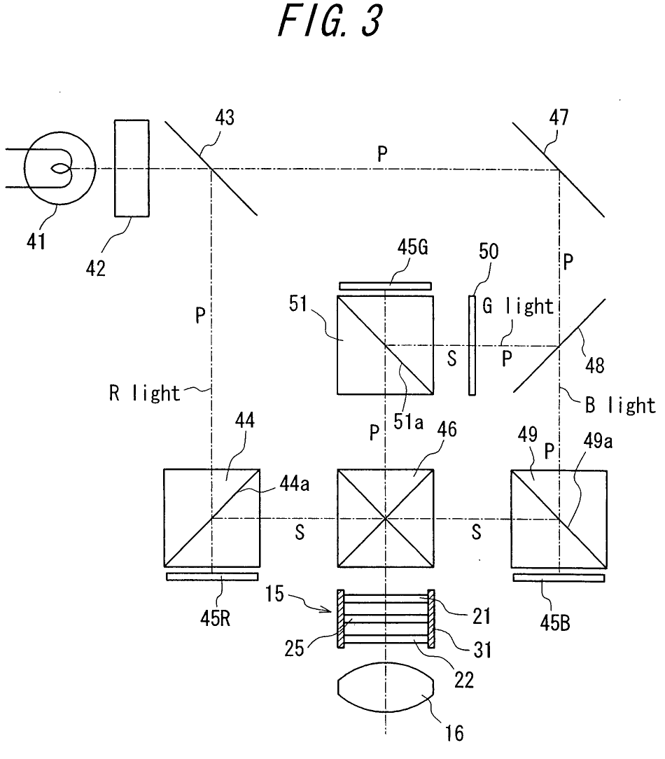

FIG. 3 is a schematic diagram of an image display device according to a second embodiment of the present invention. In the present embodiment, three reflective spatial light modulation elements are used, which are in the form of reflective liquid crystal display elements or DMDs (digital micro mirror devices), for example, and a dichroic prism is used as a color synthesizer.

With reference to FIG. 3, an illumination light emitted from a white light source 41 is transmitted through an integrator optical system 42 and is projected to a dichroic mirror 43 in P-polarization, so that the R light is reflected while the lights of other wavelengths are transmitted, thereby separating the R light.

The R light separated by the dichroic mirror 43 is projected to a polarizing beam splitter 44 and transmitted through a multiple layer 44a thereof. The R light from this polarizing beam splitter 44 is projected to a spatial light modulation element 45R for the R light as an illumination light to be subjected to an image modulation by the spatial light modulation element 45R. The R light modulated by the spatial light modulation element 45R is converted into S-polarization since the spatial light modulation element 45R is a reflective one, and thus the R light is reflected on the multiple layer 44a of the polarizing beam splitter 45 and is projected to the dichroic prism 46 as a color synthesizer.

The lights transmitted through the dichroic mirror 43, on the other hand, are projected to a dichroic mirror 48 through a reflecting mirror 47, so that the B light is transmitted while the G light is reflected, thereby separating the B and G lights from each other. The B light separated by the dichroic mirror 48 is projected to a polarizing beam splitter 49 and transmitted through a multiple layer 49a thereof. The B light from the polarizing beam splitter 49 is projected to a spatial light modulation element 45B for the B light as an illumination light, and subjected to an image modulation by the spatial light modulation element 45B to be converted into S-polarization. The S-polarized B light modulated by the spatial light modulation element 45B is reflected on the multiple layer 49a of the polarizing beam splitter 49 and projected to the dichroic prisms 46.

The polarization plane of the G light separated by the dichroic mirror 48 is rotated by 90 degrees by means of a half-wavelength plate 50 to be converted into S-polarization. The G light is then projected to a polarizing beam splitter 51 and reflected on a multiple layer 51a thereof. The G light from the polarizing beam splitter 51 is projected to a spatial light modulation element 45G for the G light as an illumination light, and subjected to an image modulation by the spatial light modulation element 45G to be converted into P-polarization. The P-polarized G light modulated by the spatial light modulation element 45G is transmitted through the multiple layer 51a of the polarizing beam splitter 51 and projected to the dichroic prism 46.

At the dichroic prism 46, the S-polarized R light modulated by the spatial light modulation element 45R and the S-polarized B light modulated by the spatial light modulation element 45B are reflected while the P-polarized G light modulated by the spatial light modulation element 45G is transmitted, and the images of the R, G and B lights are synthesized and emitted.

The polarizations of the image lights modulated by the spatial light modulation elements 45R, 45G and 45B are aligned with each other with the use of a pixel shift device 15 and a laminated phase plate 25. The pixel shift device 15 is of double-point pixel shift configuration and made into a unit comprising a set of a polarization conversion element 21 and a double refraction plate 22 which are integrally held by a holder member 31. The laminated phase plate 25 is provided between the polarization conversion element 21 and the double refraction plate 22 and made into a part of the unitized pixel shift device 15. The optical paths of the image lights are shifted thereby being synchronous with an image modulation, and the image lights are then projected by means of a projection lens 16 onto a screen which is not illustrated.

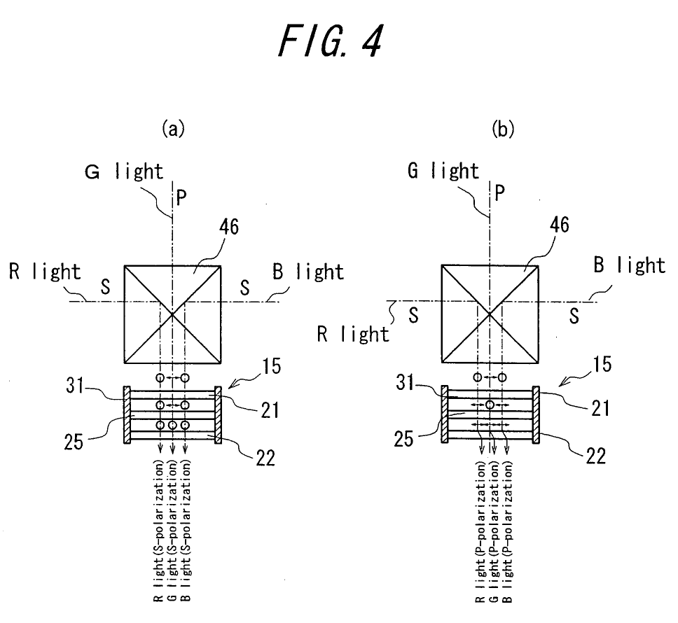

In the present embodiment, in the same way as in Embodiment 1, in the ON state of the polarization conversion element 21, the image lights synthesized by the dichroic prism 46 are projected to the laminated phase plate 25 without being subjected to rotation of the polarization plane by the polarization conversion element 21, as shown in a schematic diagram in FIG. 4(a). More specifically, since the G light is projected to the laminated phase plate 25 in P-polarization while the R and B lights are projected to the laminated phase plate 25 in S-polarization, only the polarization plane of the G light is rotated by 90 degrees by means of the laminated phase plate 25 to be converted from P-polarization into S-polarization. With this, the R, G and B image lights synthesized by the dichroic prism 46 are projected to the double refraction plate 22 in uniform S-polarization. Thus, each image light is transmitted through the double refraction plate 22 without being subjected, e.g., to an optical path shift.

In the OFF state of the polarization conversion element 21, on the other hand, the image lights synthesized by the dichroic prism 46 are projected to the laminated phase plate 25 while being subjected to rotation of the polarization plane at the polarization conversion element 21, as shown in a schematic diagram in FIG. 4(b). More specifically, since the G light is projected to the laminated phase plate 25 in S-polarization while the R and B lights are projected to the laminated phase plate 25 in P-polarization, only the polarization plane of the G light is rotated by 90 degrees by means of the laminated phase plate 25 to be converted from S-polarization into P-polarization. Accordingly, the R, G and B image lights synthesized by the dichroic prism 46 are projected to the double refraction plate 22 in uniform P-polarization. Thus, each image light is transmitted through the double refraction plate 22 while being subjected to an optical path shift.

With the present embodiment, therefore, it is possible to prevent color irregularities caused by incidence angle characteristics of the dichroic prism 46 and to display an image of high quality and high resolution. Further, because the laminated phase plate 25 is made into a part of the unitized pixel shift device 15, it can be assembled in a simple manner and at low cost without any need of applying an antireflective coating to the laminated phase plate 25 or cleaning the surface thereof.

### Third Embodiment

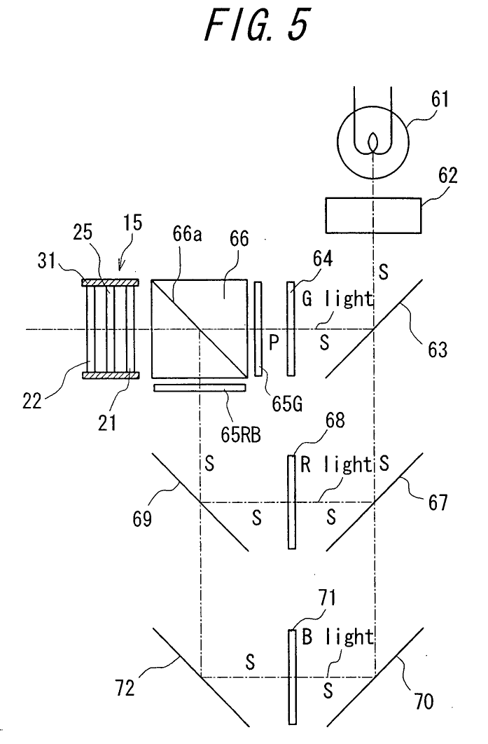

FIG. 5 is a schematic diagram of an image display device according to a third embodiment of the present invention. In the present embodiment, a transmissive spatial light modulation element for the G light and a transmissive spatial light modulation element shared for the R and B lights are used as spatial light modulation elements, and a polarizing beam splitter is used as a color synthesizer.

With reference to FIG. 5, an illumination light emitted from a white light source 61 is transmitted through an integrator optical system 62 and emitted in S-polarization to be projected to a dichroic mirror 63, whereby the G light is reflected while the lights of other wavelengths are transmitted, and the G light is thus separated.

The polarization plane of the G light separated by the dichroic mirror 63 is rotated by 90 degrees by means of a half-wavelength plate 64 as an incident polarized light controller to be converted into P-polarization. The G light is then projected to a spatial light modulation means 65G for the G light and subjected to an image modulation. The modulated G light is projected to a polarizing beam splitter 66 as a color synthesizer and is emitted through a multiple layer 66a thereof.

The lights transmitted through the dichroic mirror 63, on the other hand, are projected to a dichroic mirror 67 so that the R light is reflected while the B light is transmitted, to thereby separate the R and B lights from each other. The R light separated by the dichroic mirror 67 is reflected on a dichroic mirror 69 via a shutter 68, and projected to a spatial light modulation element 65RB that is shared for both the R and B lights. The B light separated by the dichroic mirror 67 is passed through a reflecting mirror 70, a shutter 71 and a reflecting mirror 72, transmitted through the dichroic mirror 69, and projected to the spatial light modulation element 65RB.

The shutters 68 and 71 are controlled so as to be alternately opened and closed, so that the R and B lights are subjected to a time-shared image modulation and projected to the polarizing beam splitter in S-polarization.

Since a P-polarized light is transmitted through the polarizing beam splitter 66 while an S-polarized light is reflected thereon, the P-polarized G light modulated by the spatial light modulation element 65G is transmitted through the multiple layer 66a of the polarizing beam splitter 66 while the S-polarized R or B light modulated by the spatial light modulation element 65RB is reflected on the multiple layer 66a, so that the G light and the R light, or the G light and the B light, are synthesized and then emitted.

The polarizations of the synthesized R and G lights or the synthesized B and G lights emitted from the polarizing beam splitter 66 are aligned with each other with the use of the pixel shift device 15 and the laminated phase plate 25, in the same way as in the above embodiment. The pixel shift device 15 is of double-point pixel shift configuration and made into a unit comprising a set of a polarization conversion element 21 and a double refraction plate 22 which are integrally held by a holder member 31. The laminated phase plate 25 is provided between the polarization conversion element 21 and the double refraction plate 22 and made into a part of the unitized pixel shift device 15. The optical paths of the image lights are shifted being synchronous with an image modulation, and the image lights are then projected by means of a projection lens 16 onto a screen which is not illustrated.

According to the present embodiment, in the ON state of the polarization conversion element 21, the R and G image lights or the B and G image lights synthesized by the polarizing beam splitter 66 are projected to the laminated phase plate 25 without being subjected to rotation of the polarization plane at the polarization conversion element 21. More specifically, since the G light is projected to the laminated phase plate 25 in P-polarization while the R or B light is projected to the laminated phase plate 25 in S-polarization, only the polarization plane of the G light is rotated by 90 degrees by means of the laminated phase plate 25 and thereby converted from P-polarization into S-polarization. With this, the R and G image lights or the B and G image lights synthesized by the polarizing beam splitter 64 are projected to the double refraction plate 22 in uniform S-polarization. Thus, each image light is transmitted through the double refraction plate 22 without being subjected to e.g. an optical path shift.

In the OFF state of the polarization conversion element 21, on the other hand, the R and G image lights or the B and G image lights synthesized by the polarizing beam splitter 66 are projected to the laminated phase plate 25 while being subjected to rotation of the polarization plane at the polarization conversion element 21. More specifically, since the G light is projected to the laminated phase plate 25 in S-polarization while the R or B light is projected to the laminated phase plate 25 in P-polarization, only the polarization plane of the G light is rotated by 90 degrees by means of the laminated phase plate 25 and thereby converted from S-polarization into P-polarization. Accordingly, the R and G image lights or the B and G image lights synthesized by the polarizing beam splitter 66 are projected to the double refraction plate 22 in uniform P-polarization. Thus, each image light is transmitted through the double refraction plate 22 while being subjected to an optical path shift. In this way, by modulating the G light and the time-shared R and B lights synchronously with the ON/OFF states of the polarization conversion element 21 of the pixel shift device 15, an image of higher resolution can be displayed.

Accordingly, with the present embodiment, it is possible to prevent color irregularities caused by incidence angle characteristics of the polarizing beam splitter 66 and to display an image of high quality and high resolution. Further, since the laminated phase plate 25 is made into a part of the unitized pixel shift device 15, the polarization conversion element 21, it can be assembled in a simple manner and at low cost without any need of applying an antireflective coating to the laminated phase plate 25 or cleaning the surface thereof.

### Fourth Embodiment

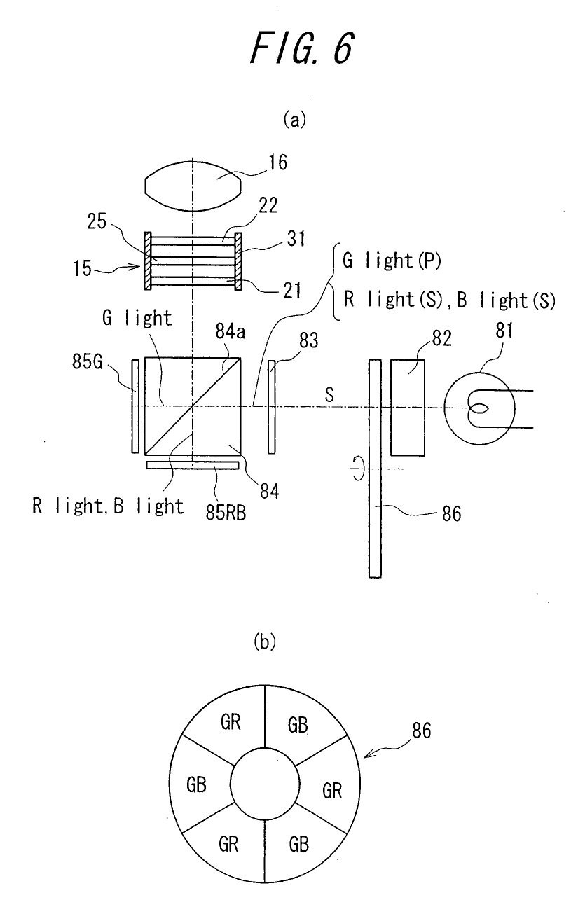

FIG. 6 is a diagram for explaining an image display device according to a fourth embodiment of the present invention. FIG. 6(a) shows an overall schematic configuration, while FIG. 6(b) shows a configuration of an example of a rotating color filter shown in FIG. 6(a). In the present embodiment, a reflective spatial light modulation element for the G light and a reflective spatial light modulation element shared for the R and B lights are used as spatial light modulation elements, and a polarizing beam splitter is used as a color synthesizer.

With reference to FIG. 6(a), an illumination light from a white light source 81 is transmitted through an integrator optical system 82 and emitted in S-polarization, and this S-polarized illumination light is transmitted through the rotating color filter 86 and a color-selective polarization conversion element 83 as an incident polarized light controller, and then projected to a polarizing beam splitter 84 as a color synthesizer.

The rotating color filter 86 comprises, for example as shown in a plan view of FIG. 6(b), equally divided six regions of a circle, which are alternately provided therein with a color filter GB for transmitting the G and B lights therethrough, or a color filter GR for transmitting the G and R lights therethrough. With rotation of the rotating color filter 86, the GB light and the GR light are switched in a time-shared manner. Here, the color-selective polarization conversion element 83 converts the G light into P-polarization, and it may be the laminated phase plate explained in the above embodiment.

P-polarized light is transmitted through the polarizing beam splitter 84 while S-polarized light is reflected thereon. G light included in GB illumination light or GR illumination light projected to the polarizing beam splitter 84 in a time-shared manner, which has been converted into P-polarization by means of the color-selective polarization conversion element 83, is transmitted through a multiple layer 84a and projected to a reflective spatial light modulation element 85G for the G light, whereby the G light is subjected to an image modulation and converted into S-polarization. The S-polarized G light modulated by the spatial light modulation element 85G is reflected on the multiple layer 84a of the polarizing beam splitter 84 and emitted.

The S-polarized R or B light incident on the polarizing beam splitter 84 in a time-shared manner is reflected on the multiple layer 84a and subjected to an image modulation by a reflective spatial light modulation element 85RB shared for the R and B lights while being converted into P-polarization. The P-polarized R or B light modulated by the spatial light modulation element 85RB is transmitted through the multiple layer 84a of the polarizing beam splitter 84 and synthesized with the G light modulated by the spatial light modulation element 85G to be emitted.

The polarizations of the synthesized R and G lights or the synthesized B and G lights emitted from the polarizing beam splitter 84 are aligned with each other with a pixel shift device 15 and a laminated phase plate 25, in the same way as in the above embodiment. The pixel shift device 15 is of double-point pixel shift configuration and made into a unit comprising a set of a polarization conversion element 21 and a double refraction plate 22 which are integrally held by a holder member 31. The laminated phase plate 25 is provided between the polarization conversion element 21 and the double refraction plate 22 and made into a part of the unitized pixel shift device 15. The optical paths of the image lights are shifted thereby being synchronous with an image modulation, and the image lights are then projected by means of a projection lens 16 onto a screen which is not illustrated.

According to the present embodiment, in the ON state of the polarization conversion element 21, the R and G image lights or the B and G image lights synthesized by the polarizing beam splitter 84 are projected to the laminated phase plate 25 without being subjected to rotation of the polarization plane by the polarization conversion element 21. More specifically, since the G light is projected to the laminated phase plate 25 in the S-polarization while the R or B light is projected to the laminated phase plate 25 in the P-polarization, only the polarization plane of the G light is rotated by 90 degrees by means of the laminated phase plate 25 and converted from the S-polarization into the P-polarization. In this instance, the R and G image lights or the B and G image lights synthesized at the polarizing beam splitter 84 are projected to the double refraction plate 22 in alignment with the P-polarization. Thus, each image light is transmitted through the double refraction plate 22 while being subjected, for example, to an optical path shift.

In the OFF state of the polarization conversion element 21, on the other hand, the R and G image lights or the B and G image lights synthesized by the polarizing beam splitter 84 is projected to the laminated phase plate 25 while being subjected to rotation of the polarization plane at the polarization conversion element 21. More specifically, since the G light is projected to the laminated phase plate 25 in G-polarization while the R or B light is projected to the laminated phase plate 25 in S-polarization, only the polarization plane of the G light is rotated by 90 degrees by means of the laminated phase plate 25 to be converted from P-polarization into S-polarization. Accordingly, the R and G image lights or the B and G image lights synthesized by the polarizing beam splitter 84 are projected to the double refraction plate 22 in uniform S-polarization. Thus, each image light is transmitted through the double refraction plate 22 without being subjected to an optical path shift. In this way, by modulating the G light and the time-shared R and B lights synchronously with the ON/OFF states of the polarization conversion element 21 of the pixel shift device 15, it is possible to display a high resolution image.

With the present embodiment, as well as with the third embodiment, it is possible to prevent color irregularities that may be otherwise caused by incidence angle characteristics of the polarizing beam splitter 84, and to display an image of high quality and high resolution. Further, since the laminated phase plate 25 is made into a part of the unitized pixel shift device 15, the polarization conversion element 21, it can be assembled in a simple manner and at low cost without any need of applying an antireflective coating to the laminated phase plate 25 or cleaning the surface thereof.

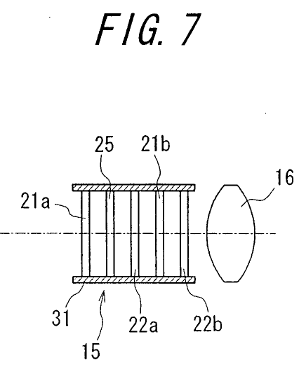

The present invention is not limited to the embodiments described above, and various modifications or changes may be made without departing from the scope of the invention. For example, the pixel shift device 15 is not limited to the double-point pixel shift configuration having a set of a polarization conversion element 21 and a double refraction plate 22, and there may be applied a four-point pixel shift configuration shown in FIG. 7, in which two sets of polarization conversion elements 21a, 21b and double refraction plates 22a, 22b are held integrally with a holder member 31 as a part of the unitized pixel shift device. Further, the pixel shift device 15 may be of a six-point pixel shift configuration in which not less than three sets of polarization conversion elements and double refraction plates are held integrally with a holder member as a part of the unitized pixel shift device, so as to allow pixel shift configurations of not less than six points. In case where the pixel shift device 15 is made into an integral unit comprising a plurality of sets of polarization conversion elements and double refraction plates, a color-selective polarization converter 25 is preferably arranged between the polarization conversion element 21a and the double refraction plate 22a of the first set of the pixel shift device 15 as a part of the unitized pixel shift device 15, as illustrated in FIG. 7.

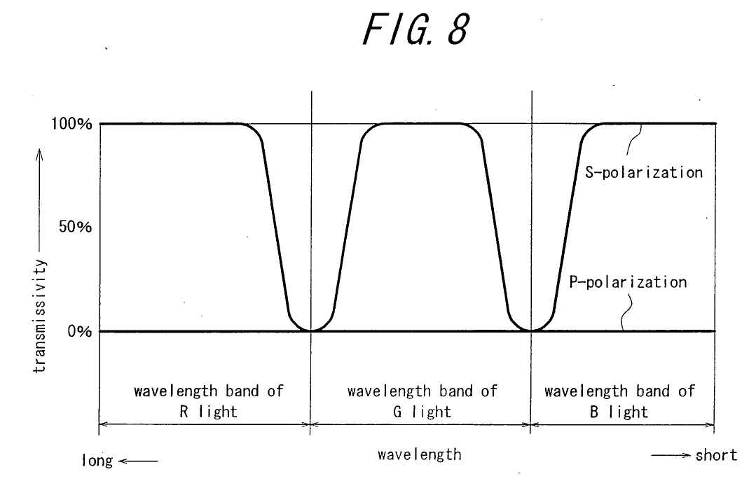

Moreover, the light source of the illumination light is not limited to a white light source, and colored light sources such as LEDs for emitting R, G and B lights may also be used. The color-selective polarization converter provided integrally with the pixel shift device may convert a polarization of the R or B light instead of that of the G light. Further, the color-selective polarization converter may also be configured to have such polarization conversion characteristics that a light in a wavelength band subjected to polarization conversion is not overlapped with a light in a wavelength band not subjected to polarization conversion, as shown in FIG. 8. In this instance, since the P-polarized component is not mixed with the S-polarized component in the wavelength regions ranging from the longer wavelength band of the B light to the shorter wavelength band of the G light, and from the longer wavelength band of the G light to the shorter wavelength band of the R light, a pixel shift can be made without color mixtures, thereby allowing an image of higher quality to be displayed. In addition, instead of controlling polarization conversion characteristics of the color-selective polarization converter, similar effects may also be achieved by controlling the reflection characteristics or transmission characteristics of a coating applied on the optical elements such as a dichroic prism, a polarizing beam splitter or a dichroic mirror so that the wavelength bands of R, G and B are not overlapped. Further, when a colored light source such as an LED is used, similar effects may be achieved by using narrow-banded colored light sources so that the illumination wavelength bands of R, G and B are not overlapped.

### LISTING OF REFERENCE NUMERALS

1 white light source
2 integrator optical system
3, 8 dichroic mirror
4, 5, 9, 11 reflecting mirror
6R, 6G, 6B spatial light modulation element
7 dichroic prism
10 half-wavelength plate
15 pixel shift device
16 projection lens
21, 21a, 21b polarization conversion element
22, 22a, 22b double refraction plate
25 laminated phase plate
31 holder member
41 white light source
42 integrator optical system
43, 48 dichroic mirror
44, 49, 51 polarizing beam splitter
44a, 49a, 51a multiple layer
45R, 45G, 45B spatial light modulation element
66 polarizing beam splitter
66a multiple layer
68, 71 shutter
70, 72 reflecting mirror
81 white light source
82 integrator optical system
83 color-selective polarization conversion element
84 polarizing beam splitter
85G, 85R, 85B spatial light modulation element
86 rotating color filter
91 color-selective polarization converter

1. An image display device comprising:
a plurality of spatial light modulation elements illuminated by lights of different colors for performing an image modulation;
a color synthesizer for synthesizing image lights modulated by said spatial light modulation elements, respectively;
an incident polarized light controller for converting at least one of said plurality of image lights of different colors projected to said color synthesizer, into a different polarization than those of the other image lights;
a pixel shift device comprised of at least one set of a polarization conversion element and a double refraction plate, said pixel shift device being for selectively shifting the optical paths of the image lights synthesized by said color synthesizer; and
a color-selective polarization converter arranged between said polarization conversion element and said double refraction plate forming a first set in said pixel shift device, said color-selective polarization converter forming an integral unit together with said pixel shift device and aligning polarizations of said plurality of image lights from said polarization conversion element with each other, before the image lights are projected to said double refraction plate.

2. The image display device according to claim 1, wherein said color synthesizer comprises a dichroic prism.

3. The image display device according to claim 1, wherein said color synthesizer comprises a polarizing beam splitter.

4. The image display device according to claim 1, wherein said plurality of spatial light modulation elements comprise three spatial light modulation elements for performing an image modulation for a red light, a green light and a blue light, respectively, and said green light is projected to said color synthesizer in P-polarization, while said red light and said blue light are projected to said color synthesizer in S-polarization, respectively.

5. The image display device according to claim 1, wherein said plurality of spatial light modulation elements comprise a spatial light modulation element for performing an image modulation for a green light and a spatial light modulation element for selectively performing an image modulation for a red light and a blue light, respectively, and said green light is projected to said color synthesizer in P-polarization, while said red light and said blue light are projected to said color synthesizer in S-polarization, respectively.

6. The image display device according to claim 1, wherein each of said plurality of spatial light modulation elements comprises a transmissive spatial light modulation element.

7. The image display device according to claim 1, wherein each of said plurality of spatial light modulation elements comprises a reflective spatial light modulation element.

8. The image display device according to claim 1, wherein said color-selective polarization converter has such polarization converting characteristics that it performs a polarization conversion for a light in a wavelength band not being overlapped with those of said lights of different colors which have not been subjected to a polarization conversion by said color-selective polarization converter.

9. The image display device according to claim 3, wherein said plurality of spatial light modulation elements comprise three spatial light modulation elements for performing an image modulation for a red light, a green light and a blue light, respectively, and said green light is projected to said color synthesizer in P-polarization, while said red light and said blue light are projected to said color synthesizer in S-polarization, respectively.

10. The image display device according to claim 3, wherein said plurality of spatial light modulation elements comprise a spatial light modulation element for performing an image modulation for a green light and a spatial light modulation element for selectively performing an image modulation for a red light and a blue light, respectively, and said green light is projected to said color synthesizer in P-polarization, while said red light and said blue light are projected to said color synthesizer in S-polarization, respectively.

11. The image display device according to claim 5, wherein each of said plurality of spatial light modulation elements comprises a transmissive spatial light modulation element.

12. The image display device according to claim 5, wherein each of said plurality of spatial light modulation elements comprises a reflective spatial light modulation element.

13. The image display device according to claim 7, wherein said color-selective polarization converter has such polarization converting characteristics that it performs a polarization conversion for a light in a wavelength band not being overlapped with those of said lights of different colors which have not been subjected to a polarization conversion by said color-selective polarization converter.
